(19) United States
(12) Patent Application Publication
(10) Pub. No.: US 2009/0161963 A1
(43) Pub. Date: Jun. 25, 2009

(54) METHOD. APPARATUS AND COMPUTER PROGRAM PRODUCT FOR UTILIZING REAL-WORLD AFFORDANCES OF OBJECTS IN AUDIO-VISUAL MEDIA DATA TO DETERMINE INTERACTIONS WITH THE ANNOTATIONS TO THE OBJECTS

(75) Inventors: Jussi Severi Uusitalo, Hameenlinna (FI); Juha Arrasvuori, Tampere (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 11/961,467

(22) Filed: Dec. 20, 2007

(51) Int. Cl. G06K 9/00; G06K 9/46

(52) U.S. Cl. 382/203; 382/181

(57) ABSTRACT

An apparatus for determining interactions with annotations to objects based upon real-world affordances of the objects in audio-visual media data may include a processing element configured to receive image data describing one or more objects having real-world affordances, to identify the one or more objects having real-world affordances, and to create one or more semiotic regions by associating with the one or more objects interaction rules corresponding to the respective real-world affordances of the one or more objects.

### TECHNOLOGICAL FIELD

Embodiments of the present invention relate to annotating audio-visual data and, more particularly, relate to a method, apparatus and computer program product for determining interactions with annotations to objects based upon real-world affordances of the objects in audio-visual media data.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

As the flexibility and immediacy of information transfer has increased in conjunction with this expansion in computer networks, television networks, and telephony networks, so too has the organization and versatility of information content itself. One such example of increased organization and versatility of information content relates to media files, such as photographs and videos. A photograph may be annotated by attaching tags or links to other media files to a region of the photograph. The tagged or linked content may be related to the photograph. These annotations may then be associated with the photograph through the use of meta data or other similar means and the annotated content may be available to a device user who accesses the photograph without requiring the user to further search for the related annotated content. As such, users who have searched for and accessed a photograph may quickly be provided with access to related content simply by clicking on defined regions of the original photograph.

A user who uploads photographs and other media data to a system wherein it may be annotated and accessed by other users over a network still today may be required to manually identify objects within the media data for which annotations to related content are required. Recently, a system for recognizing certain objects within media data and linking them to certain content has been proposed. One application employing such a system is described in U.S. application Ser. No. 11/855,430, entitled “Method, Apparatus and Computer Program Product for Providing Standard Real World to Virtual World Links,” the contents of which are hereby incorporated herein by reference in their entirety.

Users accessing annotated media content may expect to interact with media content tagged to objects in a virtual world in similar ways as they would do with these objects in the real-world. As such, users may expect to use the real-world affordances, or at least approximations thereof, to interact with the tags attached to the objects in the media data. One such way to provide for interaction with objects based upon real-world affordances of the objects is to manually define access restrictions or other interaction rules for annotations so as to approximate the real-world affordances of the annotated objects. However, this manual process may be tedious and time consuming.

Accordingly, it may be advantageous to provide an improved mechanism for automatically identifying objects within media data, such as image data, and to utilize real-world affordances of the identified objects to determine interactions with the annotations to the objects.

### BRIEF SUMMARY

A method, apparatus and computer program product are therefore provided to determine interactions with annotations to objects based upon real-world affordances of the objects in audio-visual media data. In particular, a method, apparatus and computer program product are provided that determine objects having predefined real-world affordances depicted within audio-visual media data and create semiotic regions encompassing the objects with user interaction rules based upon the real-world affordances of the objects.

In one exemplary embodiment, a method is provided, which may include, receiving audio-visual media data describing one or more objects having real-world affordances, identifying the one or more objects having real-world affordances, and in response to the one or more objects having real-world affordances, creating one or more semiotic regions by associating with the one or more objects interaction rules corresponding to the respective real-world affordances of the one or more objects.

In another exemplary embodiment, a computer program product is provided. The computer program product includes at least one computer-readable storage medium having computer-readable program code portions stored therein. The computer-readable program code portions include first, second and third executable portions. The first executable portion is for receiving audio-visual media data describing one or more objects having real-world affordances. The second executable portion is for identifying the one or more objects having real-world affordances. The third executable portion is for creating one or more semiotic regions by associating with the one or more objects interaction rules corresponding to the respective real-world affordances of the one or more objects.

In another exemplary embodiment, an apparatus is provided, which may include a processing element configured to receive audio-visual media data describing one or more objects having real-world affordances, identify the one or more objects having real-world affordances, and create one or more semiotic regions by associating with the one or more objects interaction rules corresponding to the respective real-world affordances of the one or more objects.

In another exemplary embodiment, an apparatus is provided, which may include means for receiving audio-visual media data describing one or more objects having real-world affordances, means for identifying the one or more objects having real-world affordances, and means for creating one or more semiotic regions by associating with the one or more objects interaction rules corresponding to the respective real-world affordances of the one or more objects.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for identifying objects in audio-visual media data with real-world affordances and determining interactions with annotations to the objects based upon the real-world affordances according to an exemplary embodiment of the present invention;

FIG. 4 illustrates image data containing objects having real-world affordances according to an exemplary embodiment of the present invention; and

FIG. 5 is a flowchart according to an exemplary method for identifying objects in audio-visual media data with real-world affordances and determining interactions with annotations to the objects based upon the real-world affordances according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

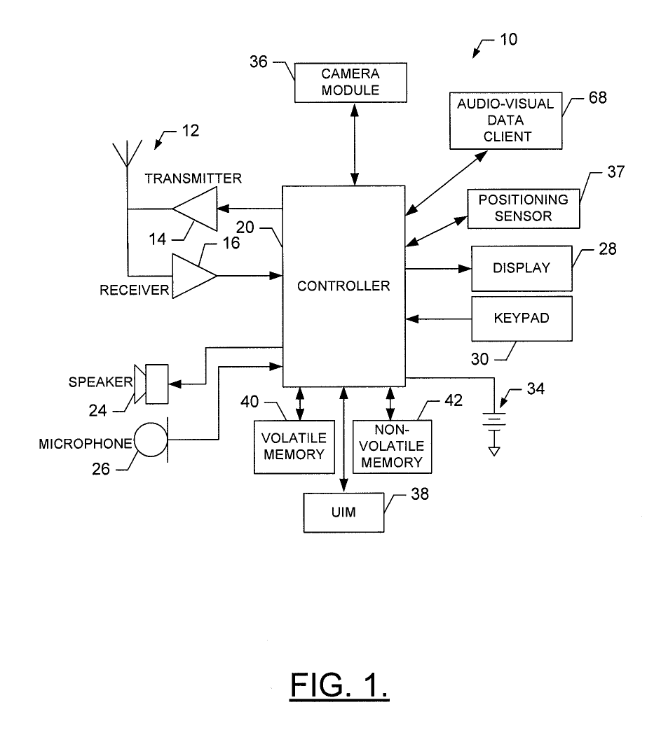

FIG. 1 illustrates a block diagram of a mobile terminal 10 that may benefit from embodiments of the present invention. It should be understood, however, that a mobile telephone as illustrated and hereinafter described is merely illustrative of one type of mobile terminal that may benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, may readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention may be utilized in conjunction with a variety of other applications, both in the mobile communications industries and outside of the mobile communications industries.

The mobile terminal 10 may include an antenna 12 (or multiple antennae) in operable communication with a transmitter 14 and a receiver 16. The mobile terminal 10 may further include an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 may further include a battery 34, such as a vibrating battery pack, for powering various circuits that are required to operate the mobile terminal 10, as well as optionally providing mechanical vibration as a detectable output.

In an exemplary embodiment, the mobile terminal 10 may include a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. In addition, the digital camera of the camera module 36 may be capable of capturing a video clip. As such, the camera module 36 may include all hardware, such as a lens or other optical component(s), and software necessary for creating a digital image file from a captured image as well as a digital video file from a captured video clip. Alternatively, the camera module 36 may include only the hardware needed to view an image, while a memory device of the mobile terminal 10 stores instructions for execution by the controller 20 in the form of software necessary to create a digital image file from a captured image. As yet another alternative, an object or objects within a field of view of the camera module 36 may be displayed on the display 28 of the mobile terminal 10 to illustrate a view of an image currently displayed which could be captured if desired by the user. As such, as referred to hereinafter, an image could be either a captured image or an image comprising the object or objects currently displayed by the mobile terminal 10, but not necessarily captured in an image file. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to, for example, a joint photographic experts group (JPEG) standard, a moving picture experts group (MPEG) standard, which may include audio data associated with the image content of the video data, or other format. Additionally, or alternatively, the camera module 36 may include one or more views such as, for example, a first person camera view and a third person map view.

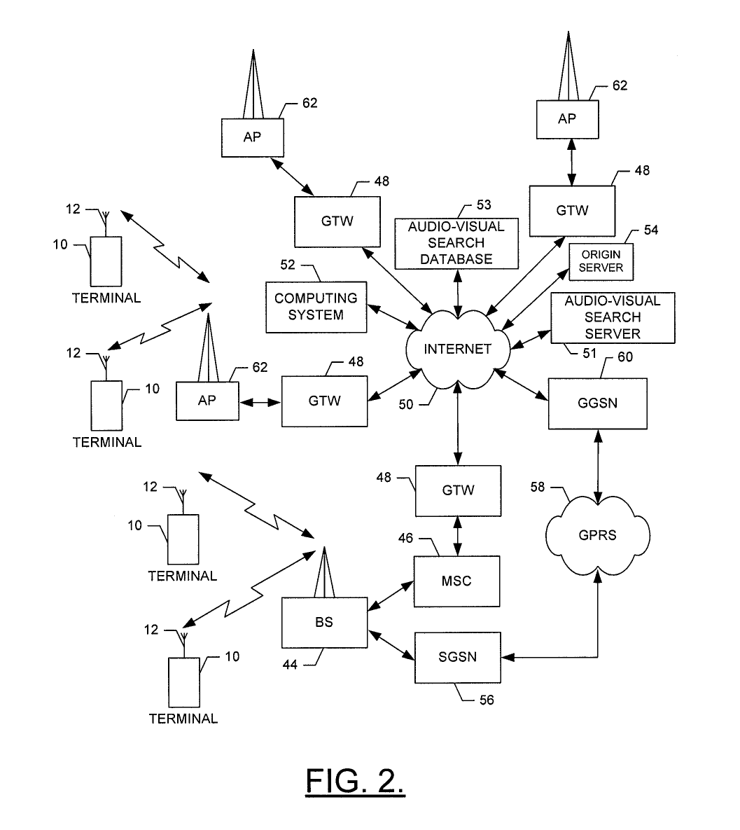

The mobile terminal 10 may further include a positioning sensor 37 such as, for example, a global positioning system (GPS) module in communication with the controller 20. The positioning sensor 37 may be any means, device or circuitry for locating the position of the mobile terminal 10. Additionally, the positioning sensor 37 may be any means, circuitry or device for locating the position of a point-of-interest (POI), in images captured by the camera module 36, such as for example, shops, bookstores, restaurants, coffee shops, department stores, businesses, houses, office buildings, as well as other structures and the like. As such, points-of-interest as used herein may include any entity of interest to a user, such as products and other objects and the like. The positioning sensor 37 may include all hardware for locating the position of a mobile terminal or a POI in an image. Alternatively or additionally, the positioning sensor 37 may utilize a memory device of the mobile terminal 10 to store instructions for execution by the controller 20 in the form of software necessary to determine the position of the mobile terminal or an image of a POI. Although the positioning sensor 37 of this example may be a GPS module, the positioning sensor 37 may include or otherwise alternatively be embodied as, for example, an assisted global positioning system (Assisted-GPS) sensor, or a positioning client, which may be in communication with a network device to receive and/or transmit information for use in determining a position of the mobile terminal 10. In this regard, the position of the mobile terminal 10 may be determined by GPS, as described above, cell ID, signal triangulation, or other mechanisms as well. In one exemplary embodiment, the positioning sensor 37 includes a pedometer or inertial sensor. As such, the positioning sensor 37 may be capable of determining a location of the mobile terminal 10, such as, for example, longitudinal and latitudinal directions of the mobile terminal 10, or a position relative to a reference point such as a destination or start point. Information from the positioning sensor 37 may then be communicated to a memory of the mobile terminal 10 or to another memory device to be stored as a position history or location information. Additionally, the positioning sensor 37 may be capable of utilizing the controller 20 to transmit/receive, via the transmitter 14/receiver 16, locational information such as the position of the mobile terminal 10 and a position of one or more POIs to a server such as, for example, a visual search server 51 and/or a visual search database 53 (see FIG. 2), described more fully below.

The mobile terminal 10 may also include an audio-visual data client 68 (e.g., a unified mobile audio-visual search/mapping client). The audio-visual data client 68 may be any means, device or circuitry embodied in hardware, software, or a combination of hardware and software that is capable of communication with the audio-visual search server 51 and/or the audio-visual search database 53 (see FIG. 2) to upload audio-visual data (e.g., an image or video clip, which may comprise audio data associated with the image data) received from the camera module 36 for determination of objects having real-world affordances, such as objects having real-world affordances within POIs (described more fully herein below) depicted in the audio-visual media data and storage in an audio-visual media data database, such as the audio-visual search database 53. The audio-visual data client 68 may further be configured to process a query (e.g., an image or video clip) received from the camera module 36 for providing results including images having a degree of similarity to the query. For example, the audio-visual data client 68 may be configured for recognizing (either through conducting an audio-visual search based on the query audio-visual data for similar images or video within the audio-visual search database 53 or through communicating the query audio-visual data (raw or compressed), or features of the query data to the audio-visual search server 51 for conducting the search and receiving results) objects and/or points-of-interest when the mobile terminal 10 is pointed at the objects and/or POIs or when the objects and/or POIs are in the line of sight of the camera module 36 or when the objects and/or POIs are captured in an image by the camera module 36. It will be appreciated that while the audio-visual search server 51 is described herein as a “server,” embodiments of the invention are not so limited and the audio-visual search server 51 may be any kind of computing device.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 may be capable of controlling the forwarding of messages to and from the mobile terminal 10, and may also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 may be coupled to a data network, such as a local area network (LAN), a metropolitan area network (MAN), and/or a wide area network (WAN). The MSC 46 may be directly coupled to the data network. In one typical embodiment, however, the MSC 46 may be coupled to a GTW 48, and the GTW 48 may be coupled to a WAN, such as the Internet 50. In turn, devices such as processing elements (e.g., personal computers, server computers or the like) may be coupled to the mobile terminal 10 via the Internet 50. For example, as explained below, the processing elements may include one or more processing elements associated with a computing system 52 (two shown in FIG. 2), origin server 54 (one shown in FIG. 2) or the like, as described below.

As shown in FIG. 2, the BS 44 may also be coupled to a signaling GPRS (General Packet Radio Service) support node (SGSN) 56. As known to those skilled in the art, the SGSN 56 may be capable of performing functions similar to the MSC 46 for packet switched services. The SGSN 56, like the MSC 46, may be coupled to a data network, such as the Internet 50. The SGSN 56 may be directly coupled to the data network. Alternatively, the SGSN 56 may be coupled to a packet-switched core network, such as a GPRS core network 58. The packet-switched core network may then be coupled to another GTW 48, such as a GTW GPRS support node (GGSN) 60, and the GGSN 60 may be coupled to the Internet 50. In addition to the GGSN 60, the packet-switched core network may also be coupled to a GTW 48. Also, the GGSN 60 may be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown in FIG. 2 and described herein, it should be appreciated that electronic devices, such as the mobile terminal 10, may be coupled to one or more of any of a number of different networks through the BS 44. In this regard, the network(s) may be capable of supporting communication in accordance with any one or more of a number of first-generation (1G), second-generation (2G), 2.5G, third-generation (3G), fourth generation (4G) and/or future mobile communication protocols or the like. For example, one or more of the network(s) may be capable of supporting communication in accordance with 2G wireless communication protocols IS-136 (TDMA), GSM, and IS-95 (CDMA). Also, for example, one or more of the network(s) may be capable of supporting communication in accordance with 2.5G wireless communication protocols GPRS, Enhanced Data GSM Environment (EDGE), or the like. Further, for example, one or more of the network(s) may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile terminals (e.g., digital/analog or TDMA/CDMA/analog phones).

As depicted in FIG. 2, the mobile terminal 10 may further be coupled to one or more wireless access points (APs) 62. The APs 62 may comprise access points configured to communicate with the mobile terminal 10 in accordance with techniques such as, for example, radio frequency (RF), Bluetooth™ (BT), infrared (IrDA) or any of a number of different wireless networking techniques, including wireless LAN (WLAN) techniques such as IEEE 802.11 (e.g., 802.11a, 802.11b, 802.11g, 802.11n, etc.), Wibree™ techniques, WiMAX techniques such as IEEE 802.16, Wireless-Fidelity (Wi-Fi) techniques and/or ultra wideband (UWB) techniques such as IEEE 802.15 or the like. The APs 62 may be coupled to the Internet 50. Like with the MSC 46, the APs 62 may be directly coupled to the Internet 50. In one embodiment, however, the APs 62 may be indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 may communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

As will be appreciated, by directly or indirectly connecting the mobile terminals 10 and the computing system 52, the origin server 54, the audio-visual search server 51, the audio-visual search database 53 and/or any of a number of other devices, to the Internet 50, the mobile terminals 10 may communicate with one another, the computing system, 52, the origin server 54, the audio-visual search server 51, the audio-visual search database 53, etc., to thereby carry out various functions of the mobile terminals 10, such as to transmit data, content or the like to, and/or receive content, data or the like from, the computing system 52, the origin server 54, the audio-visual search server 51, and/or the audio-visual search database 53, etc. The audio-visual search server 51, for example, may be embodied as one or more other servers such as, for example, a visual map server that may provide map data relating to a geographical area of one or more mobile terminals 10 or one or more points-of-interest (POI) or a POI server that may store data regarding the geographic location of one or more POI as well as objects with real-world affordances associated with the one or more POI and may store data pertaining to various points-of-interest including but not limited to location of a POI, category of a POI, (e.g., coffee shops or restaurants, sporting venue, concerts, etc.) product information relative to a POI, and the like. Accordingly, for example, the mobile terminal 10 may capture an image or video clip which may be transmitted as a query to the audio-visual search server 51 for use in comparison with images, video clips, or audio clips stored in the audio-visual search database 53. As such, the audio-visual search server 51 may perform comparisons with images or video clips taken by the camera module 36 and determine whether or to what degree these images or video clips are similar to images, video clips, or audio clips as well as to objects having real-world affordances stored in the audio-visual search database 53. The images or video clips taken by the camera module 36 may then, themselves, be stored in the audio-visual search database 53 along with any associated POIs and objects having real-world affordances.

Although not shown in FIG. 2, in addition to or in lieu of coupling the mobile terminal 10 to computing systems 52 and/or the audio-visual search server 51 and audio-visual search database 53 across the Internet 50, the mobile terminal 10 and computing system 52 and/or the audio-visual search server 51 and audio-visual search database 53 may be coupled to one another and communicate in accordance with, for example, RF, BT, IrDA or any of a number of different wireline or wireless communication techniques, including LAN, WLAN, WiMAX, UWB techniques and/or the like. One or more of the computing system 52, the audio-visual search server 51 and audio-visual search database 53 may additionally, or alternatively, include a removable memory capable of storing content, which may thereafter be transferred to the mobile terminal 10. Further, the mobile terminal 10 may be coupled to one or more electronic devices, such as printers, digital projectors and/or other multimedia capturing, producing and/or storing devices (e.g., other terminals). Like with the computing system 52, the audio-visual search server 51 and the audio-visual search database 53, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content such as audio-visual content, location information and/or POI information along with associated objects having real-world affordances may be communicated over the system of FIG. 2 between a mobile terminal, which may be similar to the mobile terminal 10 of FIG. 1 and a network device of the system of FIG. 2, or between mobile terminals. For example, a database may store the content at a network device of the system of FIG. 2, and the mobile terminal 10 may desire to upload audio-visual data to the database or to search the content of the database for a particular type of content. However, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, or may be resident on a network device or other device accessible to the communication device.

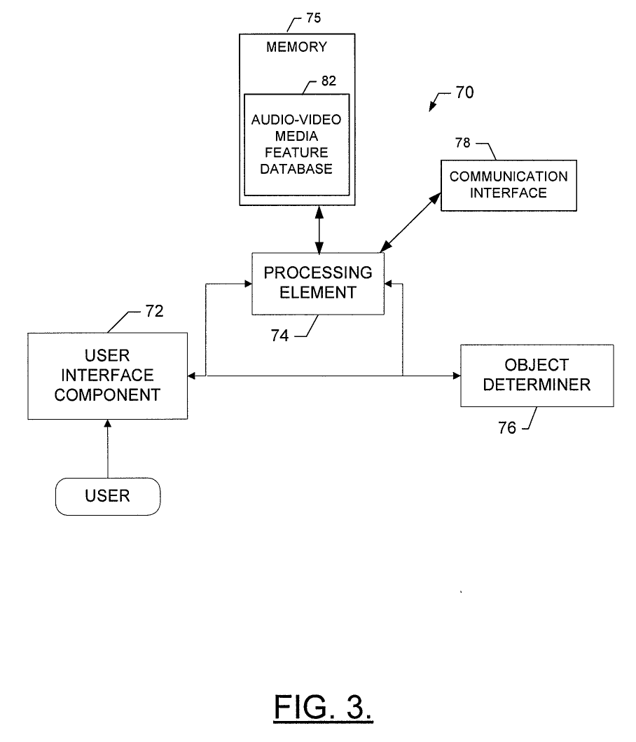

FIG. 3 illustrates a block diagram of an apparatus for identifying objects in audio-visual media data with real-world affordances and determining interactions with annotations to the objects based upon the real-world affordances according to an exemplary embodiment of the present invention. As used herein, “audio-visual media data” may include still images, video clips, video clips with associated audio data, or audio clips. Further, as used herein, “real-world affordances” may include any characteristic of an object in the real-world, such as how an individual may interact with the object in real life as well as how the real-life object may interact with or otherwise impact its surrounding environment. In other words, affordances are the action possibilities that a person perceives from an object, such as how a person perceives he may interact with an object. As such, real-world objects have specific affordances in the real-world. Digital representations of these same objects in a virtual world may have, but do not necessarily have to have, affordances similar to those the objects have in the real-world. In this regard, an object may have a primary, secondary, etc., affordances, depending on the object and the person perceiving it. Digital representations of affordances of recognized real-world objects in a virtual world are predefined. These digital representations may be predefined by any number of individuals or groups, such as, for example, individuals responsible for maintaining the audio-visual search database 53, the members of a standard-setting group, such as a group responsible for maintaining a virtual community utilizing embodiments of the invention, an owner of intellectual property rights in an object, or an individual or entity that has leased or purchased rights in a virtual world to predefine one or more affordances of an object.

The apparatus of FIG. 3 will be described, for purposes of example, in connection with the mobile terminal 10 of FIG. 1 as well as the system of FIG. 2. However, it should be noted that the apparatus of FIG. 3 may also be employed in connection with a variety of other devices, both mobile and fixed, and therefore, embodiments of the present invention should not be limited to application on devices such as the mobile terminal 10 of FIG. 1. Moreover, the apparatus of FIG. 3 may also be employed in connection with systems and communication protocols other than those described in connection with FIG. 2. In this regard, embodiments may also be practiced in the context of a client-server relationship in which the client (e.g., the audio-visual data client 68) issues a query to the server (e.g., the audio-visual search server 51) and the server practices embodiments of the present invention and communicates results to the client. Alternatively, some functions described below may be practiced on the client, while others are practiced on the server. Decisions with regard to what processes are performed at which device may typically be made in consideration of balancing processing costs and communication bandwidth capabilities. It should also be noted, that while FIG. 3 illustrates one example of a configuration of an apparatus for identifying objects in audio-visual media data with real-world affordances and determining interactions with annotations to the objects based upon the real-world affordances, numerous other configurations may also be used to implement embodiments of the present invention.

Referring now to FIG. 3, an object identifying apparatus 70 for identifying objects in audio-visual media data with real-world affordances and determining interactions with annotations to the objects based upon the real-world affordances is provided. In exemplary embodiments, the object identifying apparatus 70 may be embodied at either one or both of the mobile terminal 10 (e.g., as the audio-visual data client 68) and the audio-visual search server 51 (or another network device). In other words, portions of the object identifying apparatus 70 may be resident at the mobile terminal 10 while other portions are resident at the audio-visual search server 51. Alternatively, the object identifying apparatus 70 may be resident entirely on the mobile terminal 10 and/or the audio-visual search server 51. The search apparatus 70 may include a user interface component 72, a processing element 74, a memory 75, an object determiner 76 and a communication interface 78. In an exemplary embodiment, the processing element 74 may be embodied as the controller 20 of the mobile terminal 10 of FIG. 1 or as a processor or controller of the audio-visual search server 51. However, alternatively, the processing element 74 may be a processing element of a different device. Processing elements as described herein may be embodied in many ways. For example, the processing element 74 may be embodied as a processor, a coprocessor, a controller or various other processing means, circuits or devices including integrated circuits such as, for example, an ASIC (application specific integrated circuit). In an exemplary embodiment, the user interface component 72, the object determiner 76 and/or the communication interface 78 may be controlled by, or otherwise embodied as the processing element 74, such as by software executing on the processing element 74.

The communication interface 78 may be embodied as any device, circuitry or means embodied in either hardware, software, or a combination of hardware and software that is configured to receive and/or transmit data from/to a network and/or any other device or module in communication with an apparatus (e.g., the search apparatus 70) that is employing the communication interface 78. In this regard, the communication interface 78 may include, for example, an antenna and supporting hardware and/or software for enabling communications via a wireless communication network. Additionally or alternatively, the communication interface 78 may be a mechanism by which location information and/or audio-visual media data may be communicated to the processing element 74 and/or the object determiner 76. Accordingly, in an exemplary embodiment, the communication interface 78 may be in communication with a device such as the camera module 36 (either directly or indirectly via the mobile terminal 10) for receiving the audio-visual data and/or with a device such as the positioning sensor 37 for receiving location information identifying a position or location of the mobile terminal 10.

The user interface component 72 may be any device, means or circuitry embodied in either hardware, software, or a combination of hardware and software that is capable of receiving user inputs and/or providing an output to the user. The user interface component 72 may include, for example, a keyboard, keypad, function keys, mouse, scrolling device, touch screen, or any other mechanism by which a user may interface with the search apparatus 70. The user interface component 72 may also include a display, such as the display 28 of a mobile terminal 10, speaker, such as the speaker 24 of a mobile terminal 10, or other output mechanism for providing an output to the user. In an exemplary embodiment, rather than including a device for actually receiving the user input and/or providing the user output, the user interface component 72 may be in communication with a device for actually receiving the user input and/or providing the user output. As such, the user interface component 72 may be configured to receive indications of the user input from an input device and/or provide messages for communication to an output device. In this regard, the user interface component 72 may be a portion of or embodied as the communication interface 78.

In an exemplary embodiment, the user interface component 72 may be configured to receive audio-visual data from a user. The audio-visual data may be, for example, an image currently within the field of view of the camera module 36 (although not necessarily captured), captured image, or a video clip, which may comprise associated audio data. In other words, the audio-visual data may be a newly created image or video clip that the user has captured at the camera module 36 or merely an image currently being displayed on a viewfinder (or display) of the device employing the camera module 36. In alternative embodiments, the audio-visual data may include a raw image, a compressed image (e.g., a JPEG image), features extracted from an image, raw video data, or a compressed video clip, which may comprise associated audio data (e.g., a MPEG video). In such alternative embodiments, the audio-visual data may be stored on one or both of volatile or non-volatile memory associated with any device of the system of FIG. 2, such as volatile memory 40 and non-volatile memory 42 of a mobile terminal 10.

The memory 75 (which may be a volatile or nonvolatile memory) may include an audio-visual feature database 82. In this regard, for example, the audio-visual feature database 82 may include source images or features of source images, such as objects having predefined real-world affordances, as well as sound clips representing sounds created or otherwise made by sound-making objects having predefined real-world affordances for comparison to the audio-visual media data (e.g., an image or video captured by or an image in the viewfinder of the camera module 36). As indicated above, the memory 75 may be remotely located from the mobile terminal 10 or partially or entirely located within the mobile terminal 10. As such, the memory 75 may be memory onboard the mobile terminal 10 or accessible to the mobile terminal 10 that may have capabilities similar to those described above with respect to the audio-visual search database 53 and/or the audio-visual search server 51. Alternatively, the memory 75 may be embodied as the audio-visual search database 53 and/or the audio-visual search server 51. In an exemplary embodiment, at least some of the images and sound clips stored in the memory 75 may be source images and sounds associated with objects having one or more predefined real-world affordances. In this regard, the predefined real-world affordance may map a particular object (e.g. a door) to a particular affordance or interaction rule (e.g. requiring a user to gain entry to the door, such as by a password, in order to view content behind the door). In one embodiment, the memory 75 may store a plurality of predefined real-world affordance associations, for example, in a list. Thus, once objects within audio-visual data are matched to an object having a predefined real-world affordance (e.g., by the processing element 74 or the object determiner 76), the list may be consulted by the processing element 74 to determine the predefined real-world affordance associated with the object.

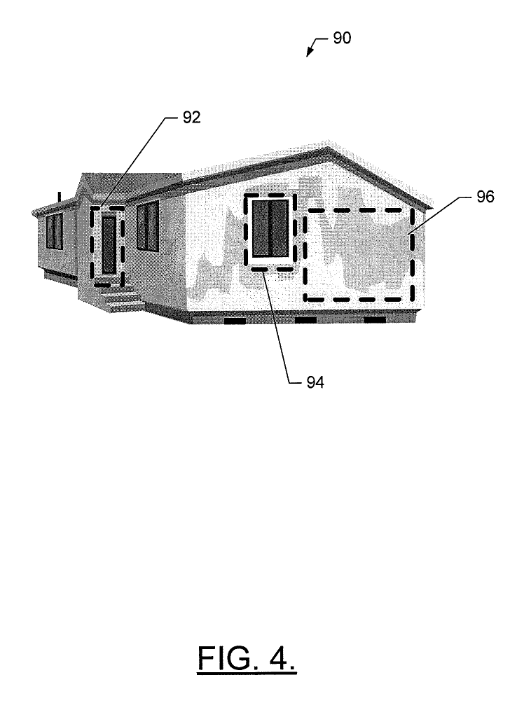

The object determiner 76 may be any device, circuit or means embodied in either hardware, software, or a combination of hardware and software that is configured to determine whether the audio-visual media data includes one or more objects with predefined real-world affordances. In this regard, the object determiner 76 may, in one exemplary embodiment, include an algorithm, device or other means for shape recognition. In such an exemplary embodiment, the shape recognition algorithm may be configured to compare objects or regions appearing in received image data to a series of known shapes, which may be stored in memory, such as the audio-visual feature database 82 of memory 75, corresponding to objects with predefined real-world affordances. Alternatively, or in addition, the object determiner 76 may be configured to compare regions or objects appearing in received audio-visual data to other images in the memory 75 (e.g., the audio-visual feature database 82), which correspond to known objects with predefined real-world affordances. As such, the object determiner 76 may be configured to compare the audio-visual media data to source images to find a source image substantially matching an object or region of the source audio-visual data with regard to at least one feature (e.g., corresponding to features of the object). Further in addition, or alternatively, the object determiner 76 may be configured to compare audio data contained within the audio-visual media data to reference audio data in the memory 75 (e.g., the audio-visual feature database 82) corresponding to predefined sound-making objects having real-world affordances to identify one or more objects having real-world affordances within the audio data. In this regard, reference audio data corresponding to, for example, the sound a door makes when being opened or closed or a sound of a breaking window may be stored in the memory 75 (e.g., the audio-visual feature database 82) and those sound clips may be compared to audio data contained in the source audio-visual media to determine if corresponding sounds are contained in the source audio data from which, a door or window object may be identified. Accordingly, an object associated with the audio-visual media data may be correlated to a particular object having a predefined real-world affordance. The object determiner 76 may, for example, receive the image data 90 of FIG. 4 and identify a door object 92, a window object 92, and a wall object 94 within the image data.

In an exemplary embodiment, the object determiner 76 may further be configured to solicit and receive an indication, such as from a user, identifying one or more objects having real-world affordances within the audio-visual media data. The object determiner 76 may, for example, solicit such an indication in situations where one or all three of the shape recognition algorithm, the image comparison, and the audio comparison fail to recognize objects in the image data. The solicitation of and receipt of an indication may be via the user interface component 72. In an exemplary embodiment, a user may be presented with a visual indication of a suspected object within the audio-visual media data and a drop down selection box from which he may select an object with a real-world affordance that corresponds with an object in the audio-visual media data.

Once the object determiner 76 has identified objects having real-world affordances within the audio-visual media data, the object determiner 76 may create semiotic regions associated with the objects. As used herein, the term “semiotic region” refers to the region of the audio-visual data encompassing a particular object having affordances similar to those of the real-world object depicted in audio-visual data. The semiotic regions may be mapped onto audio-visual data, such as the outlined semiotic regions 92-96 of FIG. 4 and stored in a separate file as metadata or in a file describing the audio-visual data itself. In an exemplary embodiment, the data defining the parameters of a semiotic region may include a tag describing the type of object having a real-world affordance contained in the semiotic region, such as a window in a building, as well as the location of the semiotic region, such as the (X,Y) coordinates of the region within the image data. Such a definition may, for example, resemble the following:

<region_type=window>
<region_location=100,100 200,200>

This example is merely one way in which to define a semiotic region and should not be construed to limit the invention in anyway. A semiotic region may be defined by any means that defines the object within the region as well as defines the spatial coordinates of the region itself. Moreover, while in the above example, the location and size of the semiotic region is described as a rectangle, the invention is not so limited and semiotic regions may be in other shapes such as triangles, polygons having more than 4 sides, circles, closed figures having squiggly lines, or other complex geometric shapes. In instances where the audio-visual media data comprises a video clip, the definition of a semiotic region may further include a dimensional parameter representing a length of time, such as a start and end time or a span of frame numbers in the video clip. Also, if the video clip is associated with a multi-track audio file, the particular audio track may be indicated in the definition of the semiotic region.

Depending on the type of object having real-world affordances depicted within a semiotic region, the semiotic region may have certain interaction rules associated with the region, which serve to emulate the real-world affordances of the depicted object within a virtual world. As used herein, “interaction rules” may define user permissions relating to the region, such as whether a given user may annotate and/or access annotated content within the semiotic region, or may define a category of content which may be accessed or annotated from within the semiotic region. Accordingly, a semiotic region with defined interaction rules emulating real-world affordances of objects depicted within the semiotic region may act, for example, like an icon on a standard computer desktop insofar as, similar to clicking on an icon which establishes a link to corresponding functionality or content, clicking within or otherwise accessing a semiotic region with defined interaction rules may allow a user to execute corresponding functionality or access corresponding content depending on the associated user interaction rules. Examples of objects having real-world affordances and their associated user interaction rules to emulate the real-world affordances within the virtual world include:

a window object, such as a window in a building (e.g. window object 94 of FIG. 4), wherein annotated content beneath the window may be viewed, but not edited and additional annotations may not be made to the semiotic region by a user;

a door object, such as a door in a building (e.g. door object 92 of FIG. 4), wherein the door must be opened (opening the door may simply be a figurative exercise within a virtual interaction with image data or may comprise demonstrating authorization to access, such as by entering a password) before any annotated content behind the door (i.e. within the semiotic region) may be accessed;

a wall object, such as a fence or wall of a building (e.g. wall object 96 of FIG. 4), wherein any user may access or add annotated content to the semiotic region;

a television screen object, such as the screen of a television, wherein only video content may be annotated within or accessed from the semiotic region;

a bookshelf object, such as a bookshelf, wherein only books or other similar written a newspaper stand object, such as a kiosk selling newspapers and magazines, a store selling newspapers, or a newspaper vending machine, wherein only news stories comprising one or more of links to online news stories or RSS feeds may be annotated within or accessed from the semiotic region;

a trash bin object, such as a trash can, wherein content perceived as garbage may be annotated within or accessed from the semiotic region;

a bus object, wherein content associated with a route which the real-world bus travels may be accessed from the semiotic region; and

a game object, such as a deck of cards, video game, or a pin ball machine, wherein a user may access a game application, which may serve as a gatekeeper for other content annotated within the semiotic region that may be accessed if a user satisfies a criterion associated with the game application.

In some embodiments, the affordances or interaction rules which the object determiner 76 assigns to a semiotic region containing an object may vary depending on a user's membership in a group. For example, if an object is predefined to have multiple affordances, a first one or more affordances may be assigned to a semiotic region when the user is from a first group, a second one or more affordances may be assigned to a semiotic region when a user is from a second group, and so on. In this regard, if a user is part of a special group, such as if the user has paid a fee for access to a premium virtual world service, the user of the special group may be provided with access to or the use of additional or otherwise special affordances of an object.

In an exemplary embodiment, the object identifying apparatus 70 may further be configured to receive an indication of a location associated with audio-visual media data, such as via the communication interface 78. The indication of location may be received in conjunction with audio-visual media data and may be determined by the positioning sensor 37 of a mobile terminal 10. Alternatively, an indication of location may be entered by a user, such as over the user interface component 72 and be associated with audio-visual media data which may, for example, be stored on the memory 75. In such an exemplary embodiment, the indication of location may be used to identify the owner(s) of an object with real-world affordances depicted within a semiotic region. For example, if the audio-visual media data depicts a building having a door object, and the coordinates at which the audio-visual media data was captured and the direction from which it was captured are known, the object identifying apparatus 70 may identify the street address. The owner(s) of an object, such as the owner(s) of a pictured building having a door object may be identified through means such as housing records. The object determiner 76 may then associate further interaction rules with semiotic regions on the building, such as, for example preventing the attachment of annotations or other tags to the semiotic regions of the building without the permission of the identified owner.

In an alternative scenario, the object determiner 76 may associate ownership of an object within a semiotic region with a virtual world owner rather than a real-world owner. In this sense, rather than determining the real-world owner of a depicted building from means such as a street address, audio-visual media data may be associated with one or more virtual world communities and in each such community the depicted building may be “owned” by a virtual world owner. The virtual world owner may then be allowed to define user interaction rules for any semiotic regions containing objects with real-world affordances over which he has ownership.

In another exemplary embodiment, the object determiner 76 may further be configured to identify objects in which third parties may hold intellectual property rights, such as corporate logos, advertisements, billboards, and works of art. The object determiner 76 may then associate user interaction rules with semiotic regions containing such objects in which a third party holds intellectual property rights which prevent users from attaching annotations or other tags to the semiotic region without the permission of the intellectual property rights holder. In this way, holders of intellectual property may protect their brand or other property interests from potential defamatory annotations.

In an exemplary embodiment, the object determiner 76 may further be configured to determine temporary (or “transitory”) objects within audio-visual media data. Temporary objects are those that are transitory in nature and not part of a permanent location as they relate to the image data, such as for example, cars, bicycles, or pedestrians which are merely passing through a scene depicted in image data. In this regard, the object determiner 76 may then associate user interaction rules with regions containing such a temporary object, which prevent the addition of annotations, comments, or other tags within the region. Such a configuration may be particularly advantageous in an image driven navigation service wherein annotations may be added to permanent objects within searchable image data. Additionally or alternatively, in some embodiments, the object determiner 76 may define a semiotic region containing the transitory object and associate user interaction rules with the semiotic region, which define the primary affordance of such a transitory object, namely its route of transit. For example, if the identified transitory object is a bus and the route of the bus is known by the system 70, such as by recognizing a number identifying the bus or accessing GPS coordinates of where the audio-visual data was captured and then retrieving the route of the bus from a database, the user may use the semiotic region containing the bus to access media such as images or video that may be found along the real-world route of the bus. In such embodiments, the system 70 may automatically assemble the images or video in a sequential slideshow presented in the order that an individual riding the bus in the real world would see the real-world scenes depicted in the images or video. A user interacting with the virtual world audio-visual media data describing the semiotic region containing the bus may then access the slideshow by clicking within the semiotic region.

Users may interact with audio-visual media data, such as audio-visual media data stored on memory 75, associated with defined semiotic regions in a number of ways. In an exemplary embodiment, a user may interact with audio-visual media data, such as through the user interface component 72 and may interact with individual semiotic regions, such as with a curser controlled by an input object such as a mouse. A user may then “click” within a semiotic region, such as semiotic regions 92-96 of FIG. 4, to interact with the object within the semiotic region according to real-world affordances of the objects. In an alternative embodiment, a user may interact with objects appearing within semiotic regions of audio-visual media data with avatars, i.e. animated characters over which a user has direct control. A user may manipulate the positioning of an avatar within the two-dimensional space of audio-visual media data and when the avatar is close to an object with a defined real-world affordance, the visual appearance of the avatar may change to indicate the affordance and the user may perform a particular action related to the affordance with the avatar. For example, if an annotation to another image is located “behind” a door object in the audio-visual media data, the user may control the avatar through the door in the image data to access the annotation and “enter” the linked photograph. If the user interaction rules for the door object semiotic region require user permission to “open” the door object, then if the user has permission, such as by entering a password or a security certificate, the animated avatar may pick up a key when the user moves close to the door object and then use the key to “unlock” the door. In another example interaction involving an avatar, a user may “pick up” a linked media file within an annotation, represented as an icon, and “carry” the icon to a trash bin object appearing in the audio-visual media data to delete the annotation and/or the media file.

In yet another alternative embodiment, interaction with semiotic regions may be through the use of virtual characters, such as “virtual pets,” that a user does not have direct control over. The characters may have some artificial intelligence or may be agents given only basic parameters defining how to perform tasks that are sent out to the virtual world comprised of interlinked image data containing semiotic regions. The characters may automatically perform actions on the basis of real-world affordances of objects within semiotic regions of audio-visual media data. For example, if a user has a password, a character affiliated with the user may “open” a door object in audio-visual media data and retrieve for the user a media object that is attached to the door region.

In exemplary embodiments providing for the use of avatars and virtual pets as a means to interact with objects in audio-visual media data, the avatars and virtual pets may interact with certain objects in a manner in which the objects may be used as a sort of “virtual tool” which may have an effect on other objects within the audio-visual media data. For example, an avatar or virtual pet may virtually kick a ball object depicted within the audio-visual media data. The ball object may interact with other objects within the audio-visual media data through their affordances. For example, a kicked ball may bounce off of a wall object, but may “break” a window object. Once a window object is broken in such a manner, some embodiments may alter the user interaction rules associated with the semiotic region containing the window object. For example, once a window object is “broken” by a ball or other virtual tool, a user may now be able to both view and add annotations to the semiotic region containing the window object. In a further example involving a virtual tool such as a ball, if the ball is kicked off of an edge of a scene in audio-visual media data, such as into the sky over the roof of a building, a user may then be shown other audio-visual scenes, such as audio-visual media data depicting a scene that in the real-world may be located behind the building over which roof the ball was kicked.

In an exemplary embodiment, another affordance of objects in audio-visual media data, which may be determined by the object determiner 76, is the style of an object. In this regard, the audio-visual feature database 82 may further store images or other indicia representative of various predefined styles which my be compared to audio-visual media date for the purpose of determining the style of one or more objects contained in audio-visual media data by the object determiner 76. The style of an object may, for example, be an architectural styling of a building depicted in audio-visual media data, such as Victorian or Art Nouveau. Such an identified style affordance may then be transferred to another media object such as an e-mail or Multimedia Message (MMS). In this regard, a user may interact with audio-visual media scene depicting a building object which has been identified as having an Art Nouveau styling. The user may click within the semiotic region containing the Art Nouveau styled building and be presented with an option to transfer the affordance (styling) to another media object, such as an MMS. The text of the MMS may then be reformatted to an Art Nouveau styled font and an image depicting a building in the style or an image that is otherwise representative of the style may be inserted in the background of the MMS. Further, the style of an object may affect the tools that are used by a user to interact with the semiotic region containing object or perhaps the entire audio-visual media item of which the object is a part of. For example, Art Nouveau image editing tools may be offered by the system as the preferred set of tools when editing an image of a building object in Art Nouveau style. Alternatively, if an image contains a building or other object determined to be in the cultural or architectural style of Japan, the image editing tools offered by the system may default to the Japanese character set when a user attempts to add text to the semiotic region. Other examples of style affordances may include, for example, a color, pattern, art style, or cultural style. If a corporation or other third party entity has intellectual property rights in a particular style, then that third party may prohibit the use of affordances of their style(s).

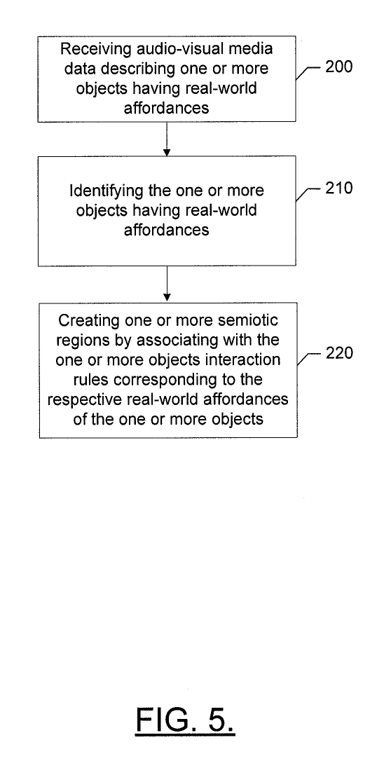

FIG. 5 is a flowchart of a method and program product according to exemplary embodiments of the invention. It will be understood that each block or step of the flowcharts, and combinations of blocks in the flowcharts, may be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of a mobile terminal or server and executed by a built-in processor in a mobile terminal or server. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for identifying objects in image data with real-world affordances and determining interactions with annotations to the objects based upon the real-world affordances as illustrated, for example, in FIG. 5, may include receiving audio-visual media data describing one or more objects having real-world affordances at operation 200. At operation 210, the one or more objects having real-world affordances may be identified. One or more semiotic regions may then be created by associating with the one or more objects interaction rules corresponding to the respective real-world affordances of the one or more objects at operation 230.

Accordingly, embodiments of the invention may be particularly useful in “augmented” or “mixed” reality settings, such as navigation services wherein a user may wish to interact with audio-visual media data stored within such a service in an intuitive way emulating the use of real-world affordances of objects in the audio-visual media data. Furthermore, the automated nature of embodiments of the system easily allows for the expansion of the service in terms of image data content without requiring the manual identification of objects and subsequent defining of interaction rules for semiotic regions containing the objects.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving audio-visual media data describing one or more objects having real-world affordances;
identifying the one or more objects having real-world affordances; and
in response to the one or more objects having real-world affordances, creating one or more semiotic regions by associating with the one or more objects interaction rules corresponding to the respective real-world affordances of the one or more objects.

2. The method of claim 1, wherein identifying the one or more objects having real-world affordances comprises one or more of:
analyzing image data contained within the audio-visual media data with a shape recognition algorithm for identifying the one or more objects having real-world affordances;
comparing the image data to reference image data describing predefined objects having real-world affordances to identify one or more objects having real-world affordances within the image data;
comparing audio data contained within the audio-visual media data to reference audio data corresponding to predefined sound-making objects having real-world affordances to identify one or more objects having real-world affordances within the audio data; or
receiving an indication identifying one or more objects having real-world affordances.

3. The method of claim 1, further comprising receiving an indication of a location associated with the audio-visual media data and identifying one or more owners associated with an object appearing in the audio-visual media data based upon the indication of a location.

4. The method of claim 3, further comprising receiving indicia defining access rights to the object appearing in the audio-visual media data from the one or more identified owners associated with the object and associating those access rights with the object.

5. The method of claim 1, further comprising identifying one or more objects described by the audio-visual media data in which a third party has intellectual property rights and associating interaction rules with the one or more objects in which a third party has intellectual property rights, wherein the interaction rules prevent the attachment of tags, annotations, or other content to the associated objects without the permission of the third party.

6. The method of claim 1, further comprising identifying one or more transitory objects described by the audio-visual media data and associating interaction rules with the one or more transitory objects, wherein the interaction rules prevent the attachment of tags, annotations, or other content to the associated transitory objects.

7. The method of claim 1, wherein creating one or more semiotic regions by associating interaction rules corresponding to the respective real-world affordances of the one or more objects with the one or more objects comprises determining whether the identified object corresponds to a predefined association selected from the group comprising:
a window object wherein any associated content can be accessed, but not edited and additional annotations can not be made to the semiotic region;
a door object, wherein the door must be opened before any associated content can be accessed;
a wall object, wherein any user may access or add annotated content to the semiotic region;
a television screen object, wherein only video content may be annotated within or accessed from the semiotic region;
a bookshelf object, wherein only books or other similar written content can be annotated within or accessed from the semiotic region;
a newspaper stand object, wherein only news stories comprising one or more of links to online news stories or RSS feeds can be annotated within or accessed from the semiotic region;
a trash bin object, wherein content perceived as garbage can be annotated within or accessed from the semiotic region;
a bus object, wherein content associated with a route which the real-world bus travels may be accessed from the semiotic region;
a game object, wherein a game application may be accessed from the semiotic region; and
a tool object, wherein the tool object may be interacted with and have an effect on other objects in the audio-visual media data.

8. A computer program product comprising at least one computer-readable storage medium having computer-readable program code portions stored therein, the computer-readable program code portions comprising:
a first executable portion for receiving audio-visual media data describing one or more objects having real-world affordances;
a second executable portion for identifying the one or more objects having real-world affordances; and
a third executable portion for creating one or more semiotic regions by associating with the one or more objects interaction rules corresponding to the respective real-world affordances of the one or more objects.

9. The computer program product of claim 8, wherein the second executable portion includes instructions for identifying one or more objects having real-world affordances by one or more of:
analyzing image data contained within the audio-visual media data with a shape recognition algorithm for identifying the one or more objects having real-world affordances;
comparing the image data to reference image data describing predefined objects having real-world affordances to identify one or more objects having real-world affordances within the image data;
comparing audio data contained within the audio-visual media data to reference audio data corresponding to predefined sound-making objects having real-world affordances to identify one or more objects having real-world affordances within the audio data; or
receiving an indication identifying one or more objects having real-world affordances.

10. The computer program product of claim 8, further comprising a fourth executable portion for receiving an indication of a location associated with the audio-visual media data and identifying one or more owners associated with an object appearing in the audio-visual media data based upon the indication of a location.

11. The computer program product of claim 10, further comprising receiving indicia defining access rights to the object appearing in the audio-visual media data from the one or more identified owners associated with the object and associating those access rights with the object.

12. The computer program product of claim 8, further comprising a fourth executable portion for identifying one or more objects described by the audio-visual media data in which a third party has intellectual property rights and associating interaction rules with the one or more objects in which a third party has intellectual property rights, wherein the interaction rules prevent the attachment of tags, annotations, or other content to the associated objects without the permission of the third party.

13. The computer program product of claim 8, further comprising a fourth executable portion for identifying one or more transitory objects described by the audio-visual media data and associating interaction rules with the one or more transitory objects, wherein the interaction rules prevent the attachment of tags, annotations, or other content to the associated transitory objects.

14. The computer program product of claim 8, wherein the third executable portion includes instructions for creating one or more semiotic regions by associating interaction rules corresponding to the real-world affordances of the one or more objects with the one or more objects by determining whether the identified object corresponds to a predefined association selected from the group comprising:
a window object wherein any associated content can be accessed, but not edited and additional annotations can not be made to the semiotic region;
a door object, wherein the door must be opened before any associated content can be accessed;
a wall object, wherein any user may access or add annotated content to the semiotic region;
a television screen object, wherein only video content may be annotated within or accessed from the semiotic region;
a bookshelf object, wherein only books or other similar written content can be annotated within or accessed from the semiotic region;
a newspaper stand object, wherein only news stories comprising one or more of links to online news stories or RSS feeds can be annotated within or accessed from the semiotic region;
a trash bin object, wherein content perceived as garbage can be annotated within or accessed from the semiotic region;
a bus object, wherein content associated with a route which the real-world bus travels may be accessed from the semiotic region;
a game object, wherein a game application may be accessed from the semiotic region; and
a tool object, wherein the tool object may be interacted with and have an effect on other objects in the audio-visual media data.

15. An apparatus comprising a processing element configured to:
receive audio-visual media data describing one or more objects having real-world affordances;
identify the one or more objects having real-world affordances; and
create one or more semiotic regions by associating with the one or more objects interaction rules corresponding to the respective real-world affordances of the one or more objects.

16. The apparatus of claim 15, wherein the processing element is further configured to identify the one or more objects having real-world affordances based upon one or more of:
analyzing image data contained within the audio-visual media data with a shape recognition algorithm for identifying the one or more objects having real-world affordances;
comparing the image data to reference image data describing predefined objects having real-world affordances to identify one or more objects having real-world affordances within the image data;
comparing audio data contained within the audio-visual media data to reference audio data corresponding to predefined sound-making objects having real-world affordances to identify one or more objects having real-world affordances within the audio data; or
receiving an indication identifying one or more objects having real-world affordances.

17. The apparatus of claim 15, wherein the processing element is further configured to receive an indication of a location associated with the audio-visual media data and to identify one or more owners associated with an object appearing in the image data based upon the indication of a location.

18. The apparatus of claim 16, wherein the processing element is further configured to receive indicia defining access rights to the object appearing in the audio-visual media data from the one or more identified owners associated with the object and to associate those access rights with the object.

19. The apparatus of claim 15, wherein the processing element is further configured to identify one or more objects described by the audio-visual media data in which a third party has intellectual property rights and to associate interaction rules with the one or more objects in which a third party has intellectual property rights, wherein the interaction rules prevent the attachment of tags, annotations, or other content to the associated objects without the permission of the third party.

20. The apparatus of claim 15, wherein the processing element is further configured to identify one or more transitory objects described by the audio-visual media data and to associate interaction rules with the one or more transitory objects, wherein the interaction rules prevent the attachment of tags, annotations, or other content to the associated transitory objects.

21. The apparatus of claim 15, wherein the processing element is further configured to create one or more semiotic regions by associating interaction rules corresponding to the real-world affordances of the one or more objects with the one or more objects by determining whether the identified object corresponds to a predefined association selected from the group comprising:
a window object wherein any associated content can be accessed, but not edited and additional annotations can not be made to the semiotic region;
a door object, wherein the door must be opened before any associated content can be accessed;
a wall object, wherein any user may access or add annotated content to the semiotic region;
a television screen object, wherein only video content may be annotated within or accessed from the semiotic region;
a bookshelf object, wherein only books or other similar written content can be annotated within or accessed from the semiotic region;
a newspaper stand object, wherein only news stories comprising one or more of links to online news stories or RSS feeds can be annotated within or accessed from the semiotic region;
a trash bin object, wherein content perceived as garbage can be annotated within or accessed from the semiotic region;
a bus object, wherein content associated with a route which the real-world bus travels may be accessed from the semiotic region;
a game object, wherein a game application may be accessed from the semiotic region; and
a tool object, wherein the tool object may be interacted with and have an effect on other objects in the audio-visual media data.

22. An apparatus comprising:
means for receiving audio-visual media data describing one or more objects having real-world affordances;
means for identifying the one or more objects having real-world affordances; and
means for creating one or more semiotic regions by associating with the one or more objects interaction rules corresponding to the respective real-world affordances of the one or more objects.
